(19) United States
(12) Patent Application Publication
(10) Pub. No.: US 2025/0373542 A1
(43) Pub. Date: Dec. 4, 2025

(54) ROUTING PACKETS THROUGH DYNAMIC ROUTING HUBS

(71) Applicant: Veho Tech, Inc., Claymont, DE (US)

(72) Inventors: Edwin Ruben Maurice Antoine Lohmann, Medford, MA (US); Miguel Andre Fernandez, Kansas City, MO (US); Joshua P. Stupplebeen, Superior, CO (US)

(73) Assignee: Veho Tech, Inc., Claymont, DE (US)

(21) Appl. No.: 19/225,832

(22) Filed: Jun. 2, 2025

Related U.S. Application Data
(60) Provisional application No. 63/655,581, filed on Jun. 3, 2024.

(51) Int. Cl. H04L 45/00; H04L 41/16

(52) U.S. Cl. CPC H04L 45/26; H04L 41/16

(57) ABSTRACT

The present disclosure provides a method comprising obtaining packet data including provisioning targets for a plurality of packets, identifying a location of a primary routing hub for routing the plurality of packets, determining a location for an additional routing hub based on the packet data and the location of the primary routing hub, generating a plurality of routes of provisioning tasks based on the packet data, associating each of the plurality of routes of provisioning tasks with the primary routing hub or the additional routing hub, and routing the plurality of packets to the primary routing hub or the additional routing hub for retrieval by provisioning agents.

### CROSS REFERENCE TO RELATED APPLICATIONS

This application claims priority to U.S. Provisional Patent Application 63/655,581 filed Jun. 3, 2024, which application is incorporated herein by reference.

### BACKGROUND

Coordinating package delivery of variable numbers of packages having varying delivery destinations is a complex, time-sensitive task. Conventional solutions call for manual determination of delivery routes and manual assignment of packages to drivers and delivery routes.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only and are not intended to be limiting.

Delivery of packages from a central location to addresses throughout a city can lead to inefficiencies as delivery drivers travel to the central location and then to delivery addresses. Selecting a location for an additional delivery hub is a complicated process requiring consideration of delivery locations, existing delivery hub locations, and driving distances within a geographical area. Embodiments discussed herein provide for a system to determine locations for additional delivery hubs, generate package delivery routes for package delivery from a primary delivery hub and the additional delivery hubs, and provide the generated routes to delivery drivers for package delivery. In this way, package delivery across a geographic area can be optimized by adding one or more additional delivery hubs. Additional delivery hubs can expand a geographic area where deliveries can be accomplished, reduce driver stem time (i.e., driver time spent driving to and from delivery hub), and reduce driver wait time at delivery hubs. Moreover, additional delivery hubs can shorten delivery routes, increasing the speed and efficiency of delivery. The system can determine any number of additional hubs, determine locations for the additional hubs, and determine package delivery routes based on the locations of the additional hubs to increase the speed and efficiency of package delivery.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is a block diagram of an example system for coordinating package delivery.

FIG. 2 is a block diagram of an example system for determining additional hub locations.

FIG. 3 is an example map including a primary hub, a first additional hub, and a second additional hub.

FIG. 4 is an example map including a primary hub and an additional hub.

FIG. 5 is an example map including a first hub and a first set of routes associated with the first hub.

FIG. 6 is an example map including the first hub of FIG. 5, a second set of routes associated with the first hub, a second hub, and a third set of routes associated with the second hub.

FIG. 7 is an example map including the second hub of FIG. 6, a fourth set of routes associated with the second hub, a third hub, and a fifth set of routes associated with the third hub.

FIG. 8 is an example map including the third hub of FIG. 7 and a sixth set of routes associated with the third hub.

FIG. 9 is a flow chart illustrating operations of a method for routing packets to routing hubs.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

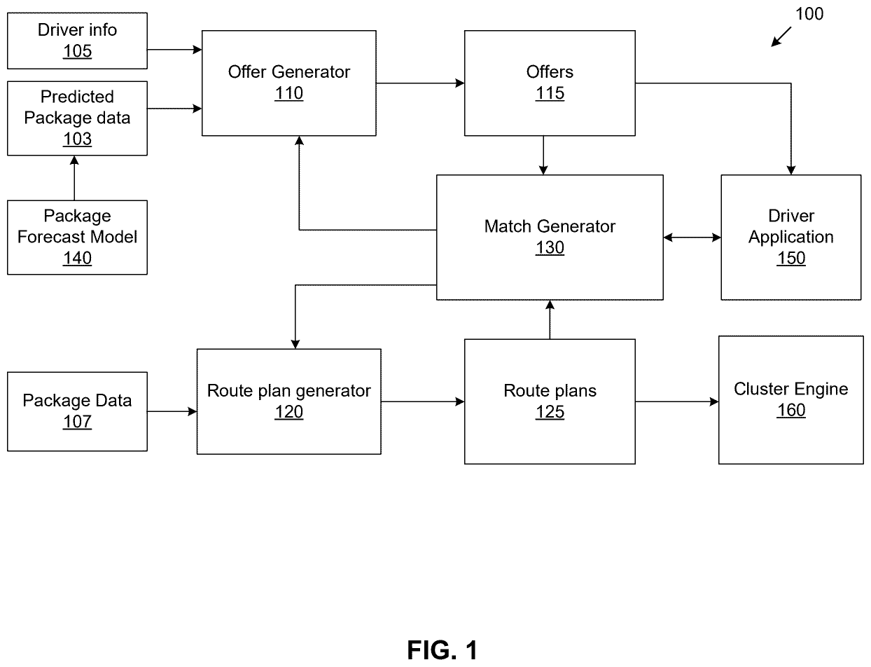

FIG. 1 is a block diagram of an example system 100 for coordinating package delivery. The system 100 includes an offer generator 110. The offer generator 110 may be a machine-learning model trained to generate offers 115. The offers 115 may be driver-facing offers to deliver packages. The offers 115 may each include one or more of a region, price, duration, and a number of packages. In some implementations, the offers 115 each one or more of a range of potential prices, a range of potential durations, and/or a range of a potential number of packages.

The offer generator 110 may receive as input predicted package data 103 and output the offers 115. The predicted package data 103 may include a prediction of one or more of a number of packages, destinations for packages, sizes of packages, and weights of packages. The predicted package data 103 may be based on historical package data as well as additional data such as weather, seasonal trends, and economic indicators. The predicted package data 103 may include predicted package volume for a future time period, before actual package volume is known. In some implementations, the predicted package data 103 may be generated by a package forecast model 140. The package forecast model 140 may be a machine-learning model. The package forecast model 140 may be trained using historical package data and/or additional data such as weather, seasonal trends, and economic indicators to generate the predicted package data 103. In an example, the package forecast model 140 is trained using a supervised training approach in which the package forecast model 140 is executed using as input historical data to generate a predicted package volume for a time period which is compared to an actual package volume for the time period. In this example, the package forecast model 140 is updated based on a difference between the predicted package volume and the actual package volume.

In some implementations, the offer generator 110 receives as input the predicted package data 103 as well as driver information 105. The driver information 105 may include driver vehicle information, such as vehicle size, vehicle height, vehicle capacity (e.g., in cubic feet), and other vehicle characteristics. In an example, the offer generator 110 receives as input the predicted package data 103 and vehicle capacity information and generates the offers 115 based on how many packages of the predicted package data 103 can fit in driver vehicles. The driver information 105 may include a ratio of successful deliveries performed by a driver, a delivery speed of the driver, a starting location of the driver, and/or prices of offers previously accepted by the driver.

The offer generator 110 may be trained using historical data. In an example, the offer generator 110 may be executed using as input historical data to generate offers for a historical time period, which offers are compared to actual, human-generated offers for the historical time period. In this example, the offer generator 110 is updated based on a difference between the generated offers for the historical time period and the actual offers for the historical time period. In some implementations, the offer generator 110 may be trained based on an acceptance rate of the offers 115. In an example, the offer generator 110 may be trained based on a speed at which the offers 115 are accepted. In an example, the offer generator 110 may be trained based on whether the offers 115 are accepted quickly enough to ensure timely delivery of packages.

The offers 115 may be provided to drivers using a driver application 150. The driver application 150 may a computer application (e.g., mobile application) which provides a user interface for drivers to view and accept the offers 115. The driver application 150 may display the offers 115 including prices, ranges of prices, region, numbers of packages, ranges of number of packages, durations, or ranges of durations. The drivers may, using the driver application 150, accept offers for current and/or future time periods. In an example, a driver accepts, using the driver application 150, an offer to deliver packages the same day when the packages are to be delivered. In an example, a driver accepts, using the driver application 150, an offer to deliver packages three days before when the packages are to be delivered. In an example, a driver accepts, using the driver application 150, an offer to deliver packages one week before when the packages are to be delivered.

The system 100 includes a route plan generator 120. The route plan generator 120 may be a machine-learning model which is executed using as input package data 107 to generate route plans 125. The package data 107 may be actual package data including a number of packages, delivery destinations of the packages, sizes and weights of the packages, and other package characteristics. The package data 107 may be received from a variety of sources. In an example, the package data 107 may be received using API calls from a plurality of merchants which need packages delivered, the API calls ingested to produce the package data 107 as input to the route plan generator 120. The route plans 125 may be routes through a delivery region. The route plans 125 may include routes for delivery drivers to take in delivering packages. The route plans 125 may be associated with packages of the package data 107 or generated based on the package data 107 but not associated with any specific packages of the package data 107. The route plans 125 may include break points representing points in the route plans where the route plans may be broken into smaller route plans if needed. In this way, portions of route plans may be moved between different route plans, providing flexibility in how packages are to be delivered.

The route plan generator 120 may receive as input the package data 107 and output the route plans 125. The route plan generator 120 may optimize the route plans 125 based on package density (e.g., density of deliveries in an area) and distance from a pickup location (e.g., distance from a warehouse where drivers pick up packages).

The route plan generator 120 may be trained to generate and optimize the route plans 125 using a supervised or semi-supervised training approach. The route plan generator 120 may be trained using historical data. In an example, the route plan generator 120 may be executed using historical data to generate route plans for a historical period which are compared to actual route plans (e.g., human-generated route plans) used for the historical period. In this example, the route plan generator 120 is 131287 updated based on a difference between the actual route plans and the generated route plans. The route plan generator 120 may be updated based on delivery statistics. In an example, the route plan generator 120 generates the route plans 125, the route plans 125 are used by drivers to deliver packages, and delivery times of the packages are used to update the route plan generator 120. In this example, the route plan generator 120 may be updated, using the delivery times of the packages, to better optimize the route plans for time between stops as well as a total delivery time for the packages.

The route plan generator 120 may begin to generate the route plans 125 once the package data 107 begins to be received. The route plan generator 120 may dynamically generate and update the route plans 125 as the package data 107 is received. The offer generator 110 may begin to generate the offers 115 before the package data 107 begins to be received. The offer generator 110 may begin to generate the offers once the predicted package data 103 is generated/received. In this way, the offers 115 may be generated before the route plans 125. The offers 115 and route plans 125 may be dynamically generated and updated until package assignments are finalized and/or until drivers pick up the packages for delivery. In this way, the offers 115 may begin to be generated before the route plans 125 begin to be generated, and the offers 115 and the route plans 125 may be dynamically generated and updated until package assignments are finalized and/or until drivers pick up the packages for delivery.

The system 100 includes a match generator 130. The match generator 130 may be a machine-learning model which is executed using as input the offers 115 and the route plans 125 to generate pairs of offers and route plans. The offer and route plan pairs generated by the match generator 130 may include an offer of the offers 115 and one or more route plans of the route plans 125. The match generator 130 may generate the offer and route plan pairs based on characteristics of the offers 115 and the route plans 125.

The match generator 130 may be trained to generate and optimize the offer and route plan pairs using a supervised or semi-supervised training approach. The match generator 130 may be trained using historical data. The match generator 130 may be executed using a set of offers and a set of route plans to generate predicted pairs which are compared to actual pairs of the set of offers and the set of route plans (e.g., human-generated pairs). The match generator 130 may be updated based on a difference between the predicted pairs and the actual pair. In some implementations, the match generator 130 may be trained based on delivery statistics resulting from implementation by drivers of generated offer and route plan pairs. In an example, the match generator 130 is updated using delivery times and delivery durations resulting from implementation of offer and route plan pairs generated by the match generator 130. In this way, the match generator 130 can learn from historical data and/or the consequences of its own output.

The match generator 130 may pass the offer and route plan pairs and/or the route plans 125 to the offer generator 110. The offer generator 110 may dynamically generate and update the offers 115 based on the offer and route plan pairs and/or the route plans 125. The updated offers 115 may be provided as input to the match generator 130 which dynamically generates and updates the offer and route plan pairs. In this way, the offers 115 are dynamically generated and updated in a cyclical manner. Similarly, the match generator 130 may pass the offer and route plan pairs and/or the offers 115 to the route plan generator 120. The route plan generator 120 may dynamically generate and update the route plans 125 based on the offer and route plan pairs and/or the offers 115. The updated route plans 125 may be provided as input to the match generator 130 which dynamically generates and updates the offer and route plan pairs. In this way, the route plans 125 are dynamically generated and updated in a cyclical manner.

In some implementations, the offers 115, the route plans 125, and the offer and route plan pairs are updated sequentially. In an example, the offer and route plan pairs are generated, the offers 115 are updated based on the offer and route plan pairs, the offer and route plan pairs are updated based on the offers 115, and the route plans 125 are updated based on the updated offer and route plan pairs and the updated offers 115. In some implementations, the offers 115 and the route plans 125 are updated in parallel. In an example, the offer and route plan pairs are generated, the offers 115 and the route plans 125 are each updated based on the offer and route plan pairs, the offer and route plan pairs are updated based on the updated offers 115 and updated route plans 125, and so on. In some implementations, the offers 115, the route plans 125, and the offer and route plan pairs are updated using a combination of sequential and parallel updates. In this way, the offers 115, the route plans 125, and the offer and route plan pairs are dynamically generated and updated in order to improve and optimize the offers 115, the route plans 125, and the offer and route plan pairs.

In some implementations, dynamically generating and updating the offers 115 and the route plans 125 includes generating new offers 115 and/or route plans 125. In an example, if not enough offers were initially generated for the package volume of the package data 107, additional offers can be generated. In an example, if too many offers were initially generated, one or more offers can be deleted and/or one or more route plans can be split to be mapped to different offers.

Each of the offers 115, the route plans 125, and the offer and route plan pairs may be updated as soon as they are initially generated and/or as soon as updated data is available. In an example, the offers 115 may be updated based on new predicted package data 103, new driver information 105, new/updated offer and route plan pairs, and/or new/updated route plans 125. In an example, the route plans 125 may be updated based on new package data 107, new/updated offer and route plan pairs, and/or new/updated offers 115. In an example, the offer and route plan pairs may be updated based on new/updated offers 115 and/or new/updated route plans 125.

The match generator 130 may provide the offer and route plan pairs to the driver application 150. The match generator 130 may provide the offer and route plan pairs to the driver application 150 based on driver check-in and/or drivers arriving to pick up packages. In some implementations, the match generator 130 may provide the offer and route plan pairs at a predetermined time prior to the drivers arriving to pick up packages in order to inform drivers beforehand of routes they will be driving. Providing the offer and route plan pairs to the driver application 150 may include providing the route plans 125 to the driver application 150 corresponding to offers of the offers 115 which have been accepted by drivers. In an example, providing the offer and route plan pairs to the driver application 150 includes identifying a driver who accepted an offer, identifying, using the offer and route plan pairs, a route plan corresponding to the offer, and sending the route plan to the driver application 150 to be displayed to the driver. In this way, drivers can view and accept the offers 115 before the package data 107 is received and before the route plans 125 are generated, and then deliver packages according to the route plans 125 once the route plans 125 are generated and paired with the accepted offers 115.

The route plans 125 may be delivered as input to a cluster engine 160. The cluster engine 160 may generate clusters of packages based on the route plans 125. The clusters may be used to sort packages for pickup by drivers for delivery. The cluster engine 160 may dynamically update the clusters based on updates to the route plans 125. In some implementations, the dynamic generation and updating of the route plans 125 is constrained by timing requirements of the package sorting process. In this way, the route plans 125 may be dynamically generated and updated for as long as feasible, or until packages need to be physically sorted according to the clusters. The drivers may pick up packages sorted by clusters for delivery using the corresponding route plans 125.

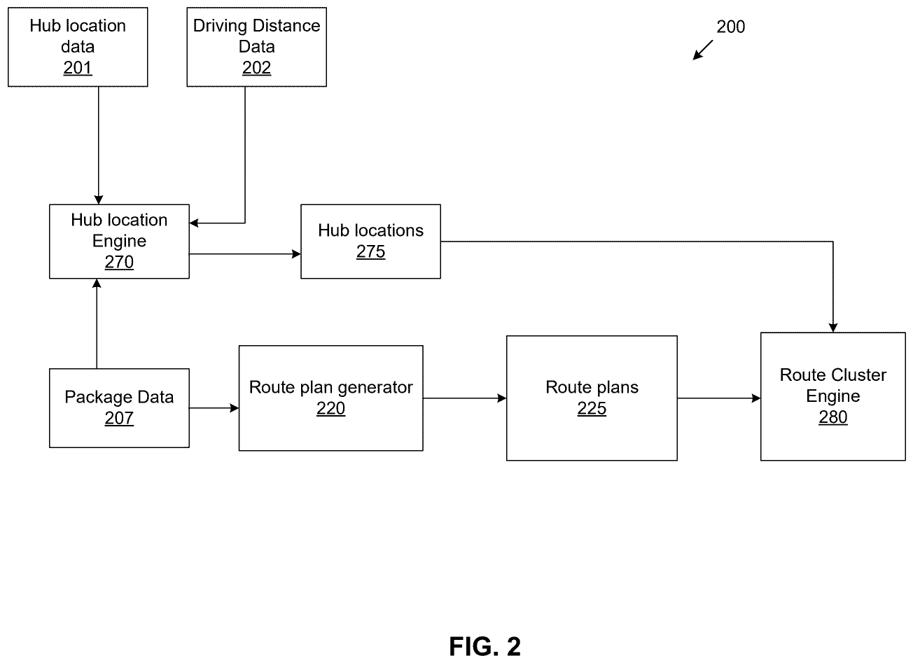

FIG. 2 is a block diagram of an example system 200 for determining additional hub locations. The system 200 may include components of the system 100 of FIG. 1 and/or may be part of the system 100 of FIG. 1.

The system 200 includes a hub location engine 270. The hub location engine 270 may receive as input hub location data 201, driving distance data 202, and package data 207 to generate hub locations 275. The hub location engine 270 may be an optimizer, such as a local search-based optimizer or an operations research optimizer. The hub location engine 270 may generate the hub locations 275 to minimize driving distance and/or driving time for delivering packages represented in the package data 207.

The hub location engine 270 can be a specialized component designed to analyze and optimize the placement of delivery hubs within a distribution network. In some implementations, the hub location engine 270 can be a machine learning model trained on historical hub location data and performance metrics. The hub location engine 270 can use various algorithms, such as genetic algorithms, simulated annealing, or particle swarm optimization, to iteratively improve hub location selections. In some cases, the hub location engine 270 can incorporate constraints such as maximum allowable distances between hubs, minimum package volume requirements for hub viability, or geographical restrictions.

In some implementations, the hub location engine 270 can be a multi-objective optimizer that balances factors such as total network cost, average delivery time, and coverage area. The hub location engine 270 can use techniques like linear programming or mixed-integer programming to solve complex hub location problems. In an example, the hub location engine 270 can employ a hierarchical approach, first determining general areas for hub placement based on high-level criteria, then refining specific locations within those areas using more detailed data.

The hub location engine 270 can also incorporate real-time data processing capabilities, allowing for dynamic adjustments to hub locations based on changing package data 207 or driving distance data 202. In some cases, the hub location engine 270 can simulate multiple hub configuration scenarios, evaluating the potential impact of each on overall network performance. The hub location engine 270 can generate heat maps or other visualizations to represent the efficiency of different hub location combinations, aiding in the decision-making process for network planners.

In some implementations, the hub location engine 270 can select predetermined areas within which to place hubs based on various criteria such as population density, existing infrastructure, or geographical features. For example, the hub location engine 270 may identify urban centers, industrial parks, or transportation hubs as potential areas for hub placement. The hub location engine 270 can utilize a grid-based approach, dividing the service area into size-configurable hexagons. In an example, the hub location engine 270 may use larger hexagons, such as 10 km across, for initial broad area selection, and then refine the selection using smaller hexagons, such as 1 km across, for more precise hub placement within the selected areas. The size of the hexagons can indicate the granularity of the hub location determination, with smaller hexagons allowing for more precise placement but potentially increasing computational complexity. In some cases, the hub location engine 270 may adjust the hexagon size dynamically based on factors such as the density of delivery locations in the package data 207 or the level of detail in the driving distance data 202.

The package data 207 may include delivery locations of packages in a geographic area. The package data 207 may be the package data 107 and/or the predicted package data 103 of FIG. 1. In an example, the package data 207 includes delivery locations for all packages to be delivered in the D.C. area on a specific day. The hub location data 201 may include locations of existing delivery hubs. In an example, the hub location data 201 includes a location of a primary delivery hub, such as a warehouse, in the D.C. area. The driving distance data 202 includes map data including driving distances between locations, allowing the hub location engine 270 to optimize for driving distance and/or driving time.

The driving distance data 202 can be calculated based on the delivery locations included in the package data 207 and map data stored in or accessible to the system 200. In some implementations, the system 200 can use a routing algorithm, (e.g., Dijkstra's algorithm) to determine the shortest paths between delivery locations and potential hub locations. The routing algorithm can take into account various factors from the map data, such as road types, speed limits, traffic patterns, or geographical obstacles, to compute more accurate driving distances and estimated travel times. In an example, the system 200 can generate a distance matrix that stores the calculated driving distances between all pairs of relevant locations (e.g., delivery addresses, existing hubs, and candidate hub locations). This pre-computed distance matrix can be used by the hub location engine 270 to efficiently evaluate different hub location configurations without recalculating distances for each iteration.

In some implementations, the hub location engine 270 receives as input a target number of delivery hubs. In an example, the hub location engine receives as input a target number of two delivery hubs including the primary delivery hub. In some implementations, the hub location engine 270 determines a number of delivery hubs. In an example, the hub location engine 270 determines that three delivery hubs, including the primary delivery hub, provide for optimal delivery. The hub location engine 270 may receive as input a cost of additional delivery hubs to determine an optimal number of delivery hubs. In some implementations, the hub location engine 270 balances the cost of the additional delivery hubs against delivery cost savings and/or increases in delivery efficiency (e.g., reduction in stem times).

The hub location engine 270 can compare the cost of implementing an additional hub against potential cost savings on driver fees. In some implementations, the hub location engine 270 can calculate the operational expenses of establishing and maintaining the additional hub, including factors such as lease costs, equipment, and staffing. The hub location engine 270 can then estimate the reduction in total driving distance and time for all routes by simulating deliveries with and without the additional hub. Based on this estimation, the hub location engine 270 can compute the potential decrease in driver fees, which may be proportional to route duration and distance. In an example, if the additional hub reduces average route duration by 20%, resulting in a 15% decrease in driver fees, the hub location engine 270 can evaluate whether the hub's operational costs are offset by these savings. The hub location engine 270 may use this cost-benefit analysis to determine if implementing the additional hub is economically advantageous for the overall delivery network.

In some implementations, the hub location engine 270 can determine the total number of hubs by generating multiple scenarios with different numbers of hubs and calculating the expected cost for each scenario. The hub location engine 270 can iterate through a range of potential hub numbers, such as from one hub to ten hubs, and for each iteration, generate a set of hub locations 275 using the package data 207, hub location data 201, and driving distance data 202. For each scenario, the hub location engine 270 can calculate the expected operational costs, including hub establishment and maintenance expenses, as well as the projected delivery costs based on the generated route plans 225. The route plan generator 220 can create route plans 225 for each scenario, which can be used by the hub location engine 270 to estimate total driving distances and times. In some cases, the hub location engine 270 can incorporate additional factors such as projected package volumes, seasonal variations, or long-term growth forecasts to refine the cost calculations. The hub location engine 270 can compare the total expected costs across all scenarios to identify the optimal number of hubs that minimizes overall expenses while meeting delivery requirements. In an example, the hub location engine 270 may determine that a scenario with four hubs provides the lowest total cost when considering both operational expenses and delivery efficiency gains.

In some implementations, the hub location engine 270 generates the hub locations 275 based on selecting a number of additional delivery hubs and locations of the additional delivery hubs from a list of available locations. In an example, the hub location engine 270 selects a location for an additional delivery hub from a list of five parking lots under contract as delivery hub candidates. In this way, the hub location engine 270 can be constrained by an availability of delivery hub sites, and selected locations can be used with confidence that they are available.

In some implementations, the package data 207 is segmented according to geographic regions and the hub locations 275 reference the geographic regions. In an example, the package data 207 is segmented into size-configurable hexagons corresponding to geographic regions, and the hub locations 275 include selections of the size-configurable hexagons. Exact locations of the delivery hubs can be determined within the size-configurable hexagons.

The route plan generator 220 generates route plans 225 based on the package data 207. The route plan generator 220 may be the route plan generator 120 of FIG. 1. The route plans 225 may be the route plans 125 of FIG. 1. The route plan generator 220 can analyze various aspects of the package data 207, such as delivery addresses, package dimensions, delivery time windows, or package weights, among others, to create optimized delivery routes. In some implementations, the route plan generator 220 can incorporate traffic patterns, road closures, and weather conditions when generating the route plans 225. The route plan generator 220 can prioritize routes based on delivery density, with areas containing multiple delivery points receiving higher priority for route optimization. In an example, the route plan generator 220 can identify that 50 packages need to be delivered to a specific suburban area, and can generate a route plan that minimizes driving distance between delivery points in that area. In some implementations, the route plan generator 220 can dynamically adjust the route plans 225 as new package data 207 is received. For example, if additional packages are added for delivery to an area already included in a route plan, the route plan generator 220 can recalculate the optimal delivery sequence to accommodate the new packages. The route plan generator 220 can also consider driver constraints, such as maximum working hours or vehicle capacity limitations, when generating the route plans 225. In some implementations, the route plan generator 220 can generate multiple alternative route plans 225 for the same set of packages, allowing for flexibility in delivery operations. For example, the route plan generator 220 can create one route plan optimized for minimum driving distance and another route plan optimized for minimum delivery time, providing options based on current delivery priorities.

The route plans 225 and the hub locations 275 are provided as input to a route cluster engine 280 that determines clusters of route plans associated with the hub locations 275. The route cluster engine 280 can analyze the geographic distribution of delivery addresses within the route plans 225 and group the route plans 225 into clusters based on proximity to the hub locations 275. In some implementations, the route cluster engine 280 can use a distance-based clustering algorithm to associate each route plan with the nearest hub location. For example, the route cluster engine 280 can calculate the average distance between delivery addresses in a route plan and each hub location to determine the most efficient hub assignment. In an example, the route cluster engine 280 determines that a first subset of the route plans 225 in a north region of a metropolitan area should be serviced by the primary delivery hub and a second subset of the route plans 225 should be serviced by an additional delivery hub. The route cluster engine 280 can dynamically adjust the clusters as new route plans 225 are generated or as hub locations 275 are updated. In some implementations, the route cluster engine 280 can balance the workload across multiple hubs by considering factors such as the number of packages, delivery time windows, or vehicle capacity constraints when forming the clusters. The route cluster engine 280 can generate visual representations of the clusters, such as color-coded maps or diagrams, to facilitate understanding of the hub-route associations. In some implementations, the route cluster engine 280 can incorporate traffic patterns, road closures, or other transportation network characteristics when determining the optimal clustering of routes to hubs.

In some implementations, the route plan generator 220 includes the route cluster engine 280, or the route plan generator 220 performs the functionality attributed to the route cluster engine 280. The route plan generator 220 may receive as input the hub locations 275 to generate the route plans 225 to include an indication of which hub location each route is associated with. The route plan generator 220 can analyze the hub locations 275 and determine optimal routes based on proximity to each hub, traffic patterns, and delivery density in surrounding areas. For example, the route plan generator 220 can determine that a first set of delivery addresses located within a 10-mile radius of the primary hub 310 should be associated with routes originating from the primary hub 310, while a second set of delivery addresses located beyond the 10-mile radius but within 8 miles of the first additional hub 320 should be associated with routes originating from the first additional hub 320. In some implementations, the route plan generator 220 can incorporate time-based constraints when generating the route plans 225, such as delivery time windows, driver availability hours, or hub operating schedules. In an example, the route plan generator 220 can determine that packages with morning delivery windows in the northern region of a service area should be assigned to routes originating from the second additional hub 330, based on the location of the second additional hub 330 relative to the delivery addresses and the morning traffic patterns in the area.

The route plan generator 220 can, in a single optimization step, determine the route plans 225 and which location the route plans 225 depart from or start from. The single optimization step can involve a comprehensive analysis of multiple factors, including driving distances between hubs and delivery addresses, package volumes at each hub, and vehicle capacity constraints. In some implementations, the route plan generator 220 can use a mixed-integer programming approach to simultaneously optimize route assignments and hub selections. For example, the route plan generator 220 can formulate an objective function that minimizes total driving distance while ensuring each delivery address is assigned to exactly one route and each route is assigned to exactly one hub. In an example, when generating route plans 225 for a metropolitan area with three delivery hubs, the route plan generator 220 can evaluate over 1,000 potential route combinations and hub assignments to identify the optimal solution that minimizes stem time and delivery time. The route plan generator 220 can also incorporate geographical constraints, such as natural barriers or restricted access zones, when determining which hub location each route should be associated with. In this way, the route plans 225 can be optimized based on the hub locations 275, resulting in more efficient delivery operations with reduced driving distances, lower fuel consumption, and improved delivery times.

The output of the route cluster engine 280 and/or the route plan generator may be provided to the cluster engine 160 of FIG. 1 such that packages are sorted according to the delivery hub associated with the route plans corresponding to the packages. In some implementations, the route plans 225 include an indication of the associated delivery hub. The packages are routed to the delivery hub associated with the delivery route for the packages, allowing the packages to be available at the appropriate hub for pickup. For example, packages associated with a first set of routes can be routed to a primary hub, while packages associated with a second set of routes can be routed to an additional hub. In some implementations, the routing of packages to the appropriate delivery hub can be performed based on the route plans 225 and the hub locations 275. The packages can be transported from a central sorting facility to the delivery hubs based on the route plans 225 and the associated hub indications. In this way, when drivers accept specific routes through the driver application 150, the drivers can pick up the packages for those routes from the corresponding delivery hub. For example, a driver who accepts a route in the a set of routes can pick up the packages for that route from a second hub. In providing offers to drivers, the modified route plans 225 and/or indications of delivery hubs may be used to indicate to drivers where to pick up packages for delivery.

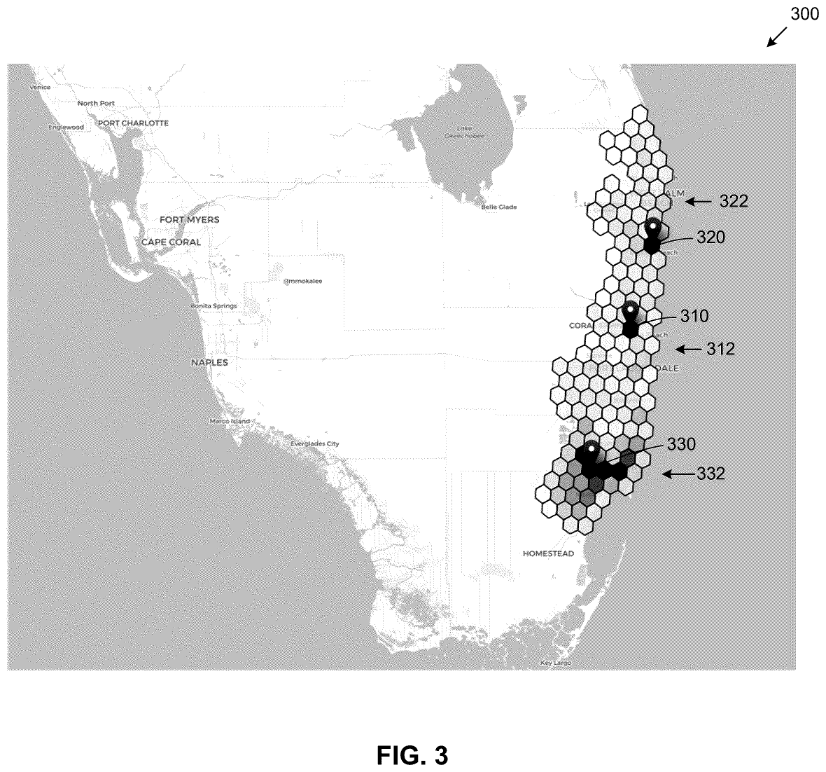

FIG. 3 is an example map 300 including a primary hub 310, a first additional hub 320, and a second additional hub 330. The primary hub 310 is located in a primary delivery area 312. The primary delivery area 312 indicates a prediction of which package delivery addresses and corresponding route plans will utilize the primary hub 310. When delivery routes (route plans) are determined, packages to be delivered utilizing the primary hub 310 (potentially in the primary delivery area 312, a first additional delivery area 322, or a second additional delivery area 332) are first delivered to the primary hub 310, picked up at the primary hub 310 by delivery drivers, and then delivered to their respective delivery addresses. The location of the primary hub 310 and the primary delivery area 312 may be defined by size-configurable hexagons, as discussed herein.

The first additional hub 320 is located in a first additional delivery area 322. The first additional delivery area 322 indicates a prediction of which package delivery addresses and corresponding route plans will utilize the first additional hub 320. When delivery routes (route plans) are determined, packages to be delivered utilizing the first additional hub 320 (potentially in the first additional delivery area 322 or the primary delivery area 312) are first delivered to the first additional hub 320, picked up at the first additional hub 320 by delivery drivers, and then delivered to their respective delivery addresses. The location of the first additional hub 320 and the first additional delivery area 322 may be defined by size-configurable hexagons, as discussed herein.

The second additional hub 330 is located in a second additional delivery area 332. The second additional delivery area 332 indicates a prediction of which package delivery addresses and corresponding route plans will utilize the second additional hub 330. When delivery routes (route plans) are determined, packages to be delivered utilizing the second addition hub 330 (potentially in the second additional delivery area 332 or the primary delivery area 312) are first delivered to the second additional hub 330, picked up at the second additional hub 330 by delivery drivers, and then delivered to their respective delivery addresses. The location of the second additional hub 330 and the second additional delivery area 332 may be defined by size-configurable hexagons, as discussed herein.

The location of the primary hub 310 may be provided as input to the hub location engine 270 of FIG. 2 to output the locations of the first additional hub 320 and the second additional hub 330 in the hub locations 275. As discussed in conjunction with FIG. 2, routes can be generated based on the locations of the primary hub 310, the first additional hub 320, and the second additional hub 330 such that the routes are optimized based on the location of the primary hub 310, the first additional hub 320, and the second additional hub 330, where each route is associated with a location of one of the primary hub 310, the first additional hub 320, and the second additional hub 330. In an example, the locations of the primary hub 310, the first additional hub 320, and the second additional hub 330 are included in the hub locations 275 and provided to the route plan generator 220 as input to generate the route plans 225 such that each of the route plans 225 include indications of the primary hub 310, the first additional hub 320, or the second additional hub from which the route plans 225 start or depart.

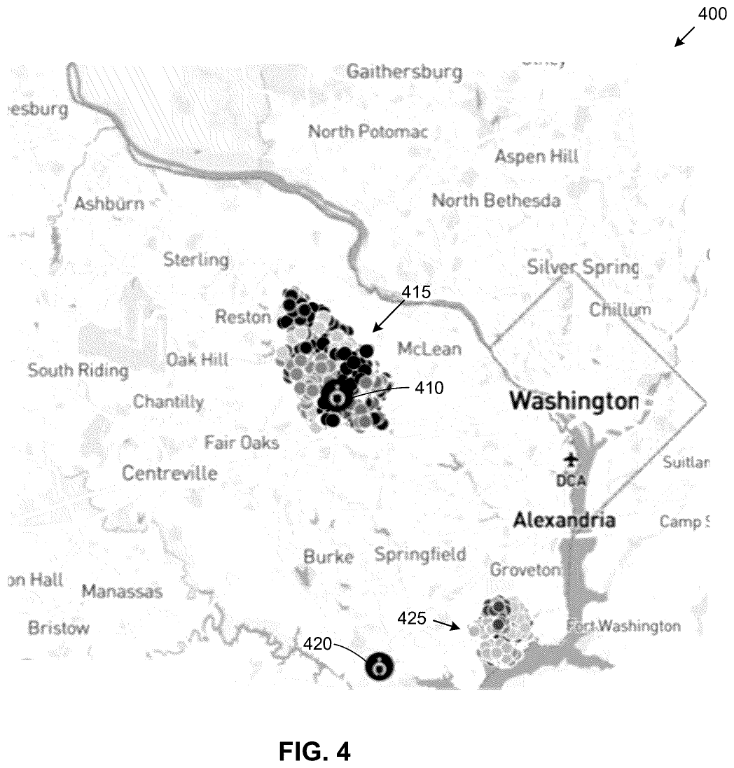

FIG. 4 is an example map 400 including a primary hub 410 and an additional hub 420. The map 400 includes a first set of routes 415 associated with the primary hub 410. The first set of routes 415 are delivery routes for packages that are picked up by delivery drivers at the primary hub 410. The map includes a second set of routes 425 associated with the additional hub 420. The second set of routes 425 are delivery routes for packages that are picked up by delivery drivers at the additional hub 420. As discussed herein, the first set of routes 415 and the second set of routes 425 can be generated based on package data (e.g., delivery addresses) and the location for the additional hub 420 such that the generation of the first set of routes 415 and the second set of routes 425 causes them to be assigned to the primary hub 410 and the additional hub 420, respectively. In some implementations, the first set of routes 415 and the second set of routes 425 can be generated based on package data (e.g., delivery addresses), and then a location for the additional hub 420 can be identified based on the first set of routes 415 and the second set of routes 425. The first set of routes 415 associated with the primary hub 410 and the second set of routes 425 associated with the additional hub 420 (i.e., which routes are associated with which hub) can be determined based on the locations of the primary hub 410 and the locations of the additional hub 420 relative to the first set of routes 415 and the second set of routes 425.

The primary hub 410 may be a permanent delivery hub, such as a warehouse, or sorting facility. The additional hub 420 may be a temporary delivery hub, such as a truck that is parked in the location of the additional hub 420 with packages for the second set of routes 425. In an example, the additional hub 420 is established by loading packages associated with the second set of routes 425 on a truck at the primary hub 410, driving the truck to the location of the additional hub 420, and instructing delivery drivers to pick up the packages for the second set of routes 425 at the additional hub 420 (i.e., at the truck). In some implementations, the additional hub 420 may be a semi-permanent delivery hub, such as a seasonal hub. In an example, the additional hub 420 is a warehouse rented during the month of December for handling large delivery volumes in December.

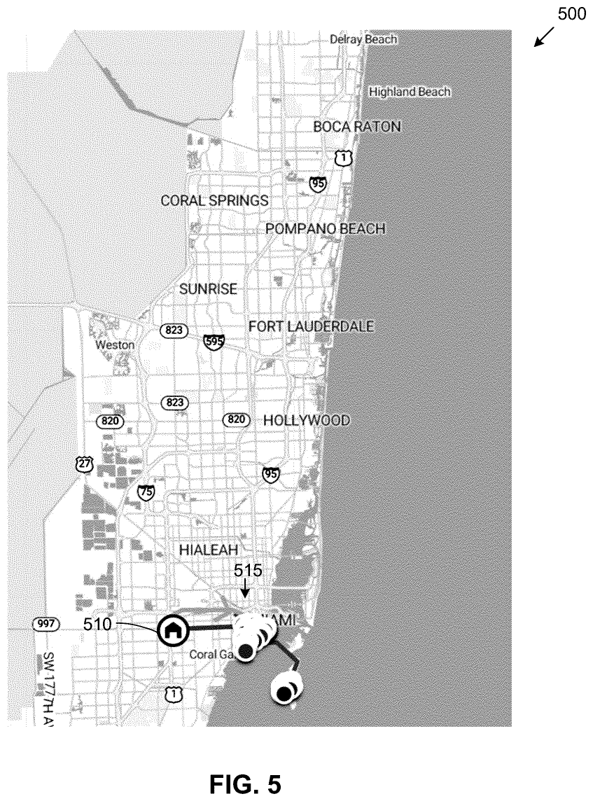

FIG. 5 is an example map 500 including a first hub 510 and a first set of routes 515 associated with the first hub.

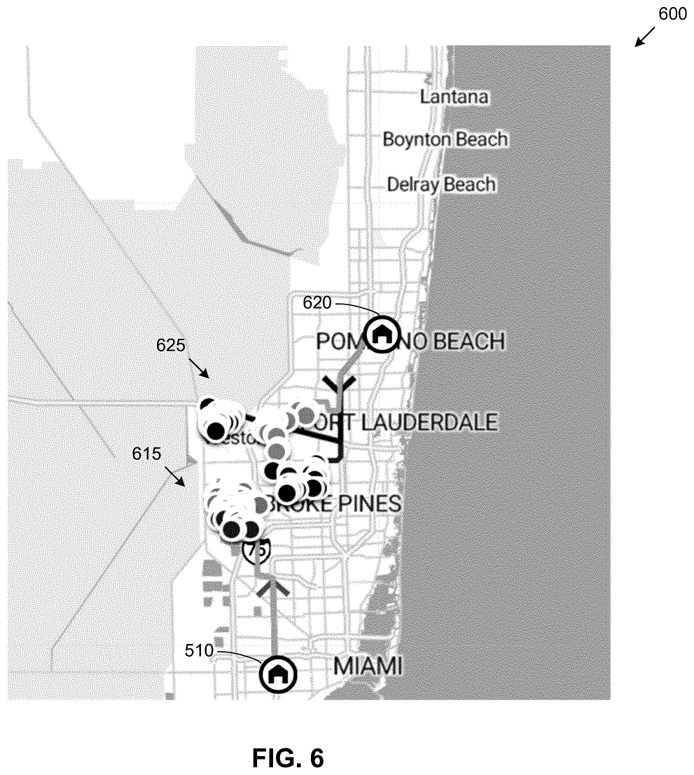

FIG. 6 is an example map 600 including the first hub of FIG. 5, a second set of routes 615 associated with the first hub 510, a second hub 620, and a third set of routes 625 associated with the second hub 620.

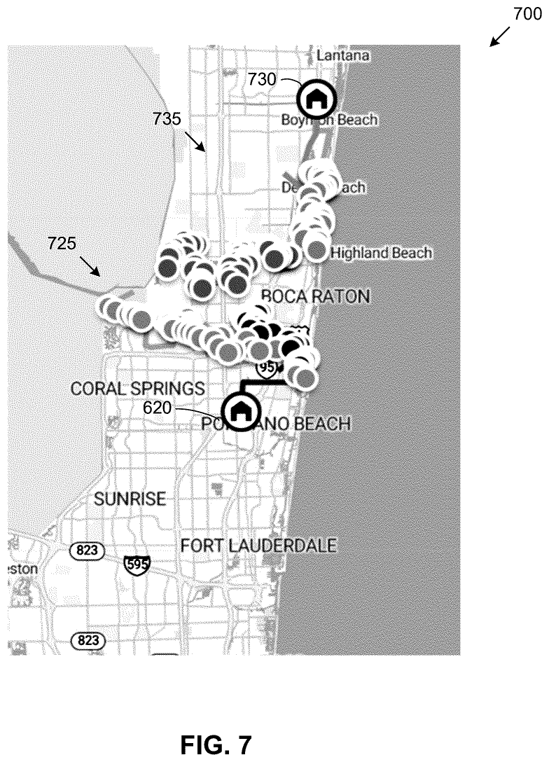

FIG. 7 is an example map 700 including the second hub 620 of FIG. 6, a fourth set of routes 725 associated with the second hub 620, a third hub 730, and a fifth set of routes 735 associated with the third hub 730.

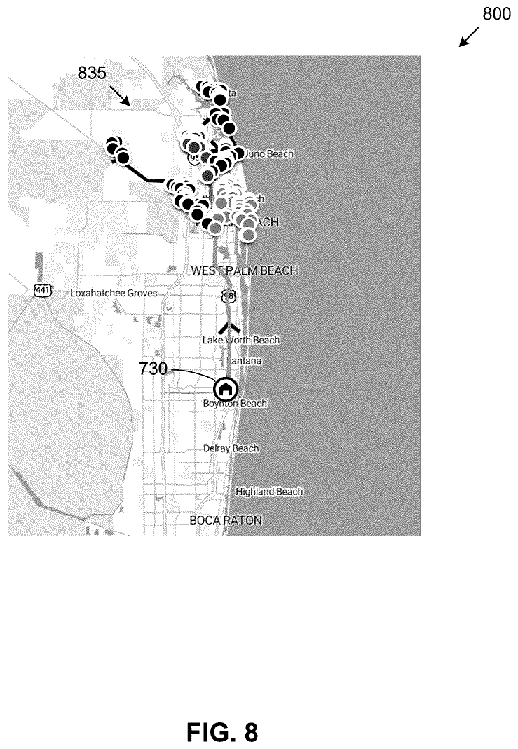

FIG. 8 is an example map 800 including the third hub 730 of FIG. 7 and a sixth set of routes 835 associated with the third hub 730.

The map 500, the map 600, the map 700, and the map 800 correspond to different views of a contiguous geographic area. In some implementations, the map 500, the map 600, the map 700, and the map 800 correspond to a portion of the geographic area portrayed in the map 300 of FIG. 3. The first hub 510 may correspond to the second additional hub 330, the second hub 620 may correspond to the primary hub 310, and the third hub may correspond to the first additional hub 320. The first set of routes 515 and the second set of routes 615 may be within the second additional delivery area 332. The third set of routes 625 and the fourth set of routes 725 may be within the primary delivery area 312. The fifth set of routes 735 and the sixth set of routes 835 may be within the first additional delivery area 322.

The map 300 of FIG. 3 provides a high-level overview of the delivery hub locations and their associated delivery areas across a broad geographic region. In contrast, the maps 500, 600, 700, and 800 of FIGS. 5-8 offer a more detailed, granular view of the delivery hub locations and their corresponding route networks. FIG. 3 illustrates the general positioning of the primary hub 310, first additional hub 320, and second additional hub 330 within their respective delivery areas 312, 322, and 332, represented by hexagonal grid patterns. FIGS. 5-8 zoom in on specific portions of the service area, showing the precise locations of the first hub 510, second hub 620, and third hub 730, along with the delivery routes associated with each hub. For example, FIG. 5 displays the first set of routes 515 emanating from the first hub 510, while subsequent figures introduce additional hubs and their corresponding route sets, such as the second set of routes 615 and third set of routes 625 shown in FIG. 6. These figures demonstrate how the route plans are distributed across multiple hubs to optimize delivery efficiency in different parts of the service area.

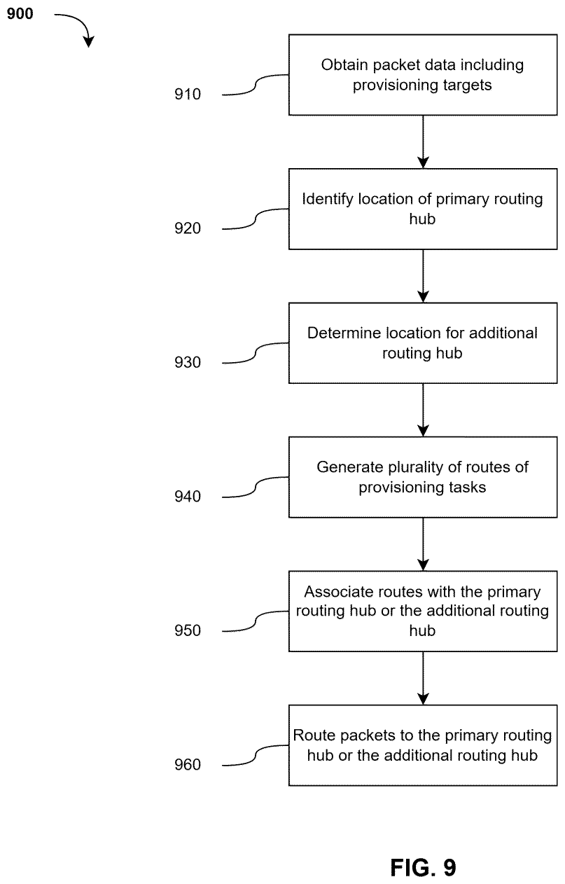

FIG. 9 is a flow chart illustrating operations of a method 900 for routing packets to routing hubs. The method 900 may include more, fewer, or different operations than shown. One or more operations may be performed in the order shown, in a different order, and/or concurrently. The method 900 may be performed by one or more components of the system 200 of FIG. 2.

At operation 910, packet data including provisioning targets for a plurality of packets is obtained. The plurality of packets can include packets, packages, parcels, and other items to be delivered. The packet data may be received from multiple sources, such as e-commerce platforms or shipping companies. In some aspects, the packet data includes package dimensions, and weight information for each packet. The provisioning targets may include delivery addresses, delivery time windows, special handling instructions, and/or priority levels for the packets. For example, the packet data may be obtained through an API integration with various retailers, allowing real-time access to order information. In some implementations, the packet data is predicted packet data. In an example, the packet data may be compiled from historical shipping records and current inventory levels to predict future packet volumes and destinations.

In some implementations, the packet data may be predicted packet data generated by executing a packet forecast machine-learning model using historical packet data as input. The packet forecast machine-learning model can be trained on historical delivery data to predict future packet volumes, destinations, and characteristics. For example, the model may analyze past seasonal trends, economic indicators, and weather patterns to forecast upcoming delivery demands. The packet forecast machine-learning model can take into account various factors such as historical order volumes, customer behavior patterns, and promotional events to generate the predicted packet data. In an example, the model may predict an increase in packet volume for certain geographic areas based on upcoming holidays or sales events. The predicted packet data generated by the model can include estimates of the number of packets, their sizes and weights, delivery locations, and delivery time windows for a future time period. This predicted packet data can be used to proactively plan routing and hub locations before actual orders are received, allowing for more efficient resource allocation and route optimization.

At operation 920, a location of a primary routing hub for routing the plurality of packets is identified. The primary routing hub location may be determined based on various factors such as geographic centrality, proximity to major transportation routes, or existing infrastructure capabilities. In some implementations, the primary routing hub location is selected from a set of pre-existing facilities. For example, the primary routing hub may be identified as a large warehouse facility located near a major highway intersection. In another example, the primary routing hub location may be determined by analyzing historical packet flow data to identify the most efficient central point for distribution. In some implementations, the primary routing hub is an existing routing hub through which packets are routed for delivery. In an example, the location of the primary routing hub is identified by identifying an address of the primary routing hub. In an example, the primary routing hub is a warehouse where packages are sorted and routed in delivery routes to be picked up by drivers who deliver the packages according to the delivery routes.

At operation 930, a location for an additional routing hub is determined based on the packet data and the location of the primary routing hub. The additional routing hub location may be selected to optimize delivery efficiency and reduce overall transportation costs. In some aspects, multiple potential locations for the additional routing hub are evaluated using a scoring system that considers factors such as distance from the primary hub, local traffic patterns, and projected packet volumes. For example, the additional routing hub location may be determined by identifying areas with high packet density that are beyond a certain radius from the primary hub. In another example, the additional routing hub location may be selected by simulating various hub configurations and choosing the option that minimizes total delivery time across all packets.

The determination to implement an additional routing hub can be based on various factors, including expected package volume, concentrations of provisioning agents in different areas, or seasonal events. In some implementations, a hub location engine can analyze historical package data and projected growth trends to identify when package volumes are likely to exceed the capacity of the primary routing hub. For example, if the package forecast model predicts a 30% increase in holiday season deliveries, the system may determine that an additional routing hub is necessary to handle the surge in volume. The concentration of provisioning agents in different areas can also influence the decision to implement an additional hub. In an example, if a high number of delivery drivers are clustered in a region distant from the primary hub, establishing an additional hub closer to their location may reduce stem times and improve overall delivery efficiency. Seasonal events, such as music festivals, sporting tournaments, or agricultural harvests, may create temporary spikes in delivery demand in specific areas. In such cases, the system can determine that a temporary additional routing hub is warranted to service the increased local demand. For instance, during a week-long technology conference that attracts thousands of attendees, an additional hub may be set up near the conference venue to handle the influx of business-related deliveries.

In some implementations, determining the location for the additional routing hub may involve selecting the location from a set of predetermined candidate locations. The system can maintain a database of potential hub locations, which may include existing facilities, available real estate, or strategic geographic points. These candidate locations can be pre-vetted for factors such as zoning regulations, accessibility, and infrastructure readiness. For example, the system may evaluate a list of available warehouses, parking lots, or temporary storage facilities within a target region. The selection process can consider various attributes of each candidate location, such as size, proximity to major transportation routes, and cost of operation. In an example, the system may choose between five pre-approved parking lots that are under contract as potential hub sites, selecting the one that best optimizes delivery routes and reduces overall transit times. The use of predetermined candidate locations can streamline the hub selection process, as it allows for rapid deployment of additional hubs when needed, without the delays associated with identifying and vetting entirely new locations. This approach may be particularly useful for implementing seasonal or event-specific hubs, where speed of setup is an important factor. For instance, during a holiday shopping season, the system can quickly activate an additional hub from a list of pre-approved locations to handle the surge in package volume.

In some implementations, the method can include determining a location for a second additional routing hub. The determination of the second additional routing hub location may be based on various factors, such as packet volume, geographic distribution of delivery addresses, and transportation network characteristics. For example, the system may analyze the packet data to identify areas with high delivery density that are not efficiently served by the primary routing hub or the first additional routing hub. In some implementations, the second additional routing hub may be positioned to cover a different geographic region or to handle specific types of packets. For instance, the second additional routing hub may be established to manage oversized or specialty items that require unique handling procedures. In an example, the system may determine that a coastal area experiences a surge in seafood deliveries during certain seasons, warranting a second additional hub equipped with refrigeration facilities. The second additional routing hub may also be implemented as a temporary or mobile hub to address fluctuating demand patterns. For example, a portable hub facility may be deployed to a location near a major sporting event or music festival to handle the temporary increase in delivery volume. By incorporating a second additional routing hub, the system can further optimize the distribution network, potentially reducing overall transit times and improving delivery efficiency across a wider service area.

In some implementations, the method can include determining locations for any number of additional routing hubs based on dynamic factors and operational requirements. The system can iteratively evaluate the need for and optimal placement of multiple additional hubs to continuously improve the distribution network. For example, as a metropolitan area expands, the system may progressively add new hubs to serve emerging suburban developments or industrial parks. In another example, a large-scale infrastructure project, such as the construction of a new airport or seaport, may prompt the addition of multiple hubs to efficiently handle increased cargo volume. The system can analyze packet flow patterns, delivery time metrics, and cost-efficiency data to determine the optimal number and locations of additional hubs. In some cases, the system may implement a hierarchical hub structure, with regional hubs feeding into local distribution centers, allowing for more granular optimization of delivery routes. The flexibility to add any number of hubs enables the system to adapt to changing market conditions, seasonal fluctuations, and long-term growth trends in packet volume and distribution patterns.

In some implementations, the method can include determining a number of routing hubs based on a cost of additional routing hubs and execution data comprising at least one of execution distance and execution time. The system can analyze the trade-offs between the costs associated with establishing and operating additional routing hubs and the potential improvements in delivery efficiency. For example, the system may calculate the reduction in total execution distance or time achieved by adding a new routing hub and compare this benefit to the operational costs of the additional hub. In an example, if adding a new routing hub reduces the total execution distance by 15% but increases operational costs by only 5%, the system may determine that an additional hub is warranted. The execution data can include metrics such as average delivery time per packet, total distance traveled by all delivery vehicles, or fuel consumption. In some implementations, the system may use a cost-benefit analysis algorithm to determine the optimal number of routing hubs. For instance, the algorithm may iteratively add hypothetical routing hubs to the network and evaluate the impact on execution data and costs until a point of diminishing returns is reached. The system can also consider factors such as projected growth in packet volume, seasonal fluctuations in demand, and long-term infrastructure development plans when determining the number of routing hubs. By balancing the cost of additional routing hubs against improvements in execution metrics, the system can optimize the routing network structure for both efficiency and cost-effectiveness.

The efficiency of execution can be quantified based on the cost of delivery, with longer routes of greater duration typically incurring higher fees paid to independent contractor drivers. In some implementations, the system can calculate a cost function that incorporates factors such as route distance, route duration, and delivery complexity for each delivery route. For example, a route that requires 8 hours of driving time may cost significantly more than a route that takes 4 hours, due to the higher fee required to compensate independent contractor drivers for longer routes. In another example, the system can assign a monetary value to delivery time, such that faster deliveries are considered more cost-effective. By quantifying the cost of delivery in this manner, the system can directly compare the operational expenses of additional routing hubs against the potential savings in driver fees. For instance, if an additional hub reduces the average route duration by 25%, resulting in a 20% decrease in fees paid to independent contractor drivers, the system can evaluate whether the hub's operational costs are offset by the delivery cost savings.

In some implementations, the method can include receiving user input indicating a target number of routing hubs. The user input may be provided through a graphical user interface, a command-line interface, or an application programming interface (API), among others. For example, a system administrator may input a desired number of routing hubs based on projected delivery volumes or budgetary constraints. In an example, a logistics manager may specify a target of three routing hubs to cover a metropolitan area during a peak shopping season. The user input can be used to guide the hub location determination process, allowing for human oversight and strategic decision-making in conjunction with automated analysis. In some implementations, the system may suggest an optimal number of routing hubs based on historical data and predictive models, and the user can adjust this suggestion through the input mechanism. For example, the system may recommend four routing hubs based on delivery efficiency calculations, but the user may override this recommendation and set a target of five hubs to account for anticipated business expansion. The ability to receive and incorporate user input regarding the target number of routing hubs provides flexibility in adapting the routing system to various operational scenarios and business objectives.

At operation 940, a plurality of routes of provisioning tasks (e.g., delivery routes) is generated based on the packet data. The routes may be optimized to minimize travel distance, reduce delivery times, or balance workload across available resources. In some implementations, the routes are generated using a machine learning algorithm that considers historical delivery data, real-time traffic information, and driver availability. For example, the routes may be generated by clustering nearby delivery addresses and sequencing stops to minimize backtracking. In another example, the routes may be created with built-in flexibility to accommodate last-minute changes or unexpected delays.

In some implementations, the plurality of routes of provisioning tasks can be generated based on the packet data and the locations of the primary routing hub and the additional routing hub. The route generation process may take into account factors such as the geographic distribution of provisioning targets (e.g., delivery addresses), the capacity of each routing hub, and the relative distances between the hubs and delivery locations. For example, a route planning algorithm may assign delivery points to the nearest routing hub, considering both straight-line distance and estimated travel time based on road networks. In another example, the route generation process may use a clustering approach to group nearby delivery addresses and then associate each cluster with the most efficient routing hub. The process may also consider load balancing between hubs, such that no hub is overwhelmed with a disproportionate number of routes. In some cases, the route generation may incorporate dynamic factors such as real-time traffic conditions or temporary road closures, adjusting the routes and hub assignments accordingly. By generating routes based on both the packet data and hub locations, the system can create more efficient delivery paths, potentially reducing overall travel distance and time for delivery vehicles.

The method 900 can include determining execution data based on the provisioning targets for the plurality of packets and path data. The execution data may comprise at least one of execution distance and execution time. In some implementations, the execution distance can be calculated as the total distance traveled by all delivery vehicles to complete their assigned routes. For example, the execution distance may be determined by summing the distances between consecutive delivery points on each route, including the distance from the routing hub to the first delivery point and from the last delivery point back to the hub. The execution time can be estimated based on factors such as the calculated distances, expected travel speeds, anticipated traffic conditions, and estimated time for each delivery stop. In an example, the execution time may include the total time required for all delivery vehicles to complete their routes, from departure from the routing hub to return. The path data used in determining the execution data may include information such as road network layouts, speed limits, historical traffic patterns, and real-time traffic updates. In some implementations, the execution data can be used to optimize route assignments and hub locations. For example, if the execution time for routes associated with one routing hub is significantly higher than for another, the system may adjust the route assignments or consider relocating the hub to balance the workload and reduce overall execution time.

In some implementations, the routes of provisioning tasks can be generated based on the packet data and the execution data. The route generation process can incorporate the execution data, such as execution distance and execution time, to optimize the delivery routes. For example, the system can use the execution distance to prioritize shorter routes or to balance the total distance traveled across multiple delivery vehicles. The execution time can be utilized to estimate the duration of each route and allocate tasks more efficiently. In an example, if the execution data indicates that certain routes consistently take longer than expected due to traffic patterns, the system can adjust the route generation algorithm to avoid congested areas during peak hours. The packet data, including delivery addresses and package characteristics, can be combined with the execution data to create more accurate and efficient routes. For instance, the system can group packages with similar delivery windows and locations while considering the historical execution times for those areas. In some implementations, the route generation process can iteratively refine the routes based on simulated execution data, adjusting the assignments until an optimal balance between package distribution and execution efficiency is achieved. This approach can lead to more realistic and achievable delivery schedules, potentially reducing delays and improving overall service quality.

At operation 950, each of the plurality of routes of provisioning tasks is associated with the primary routing hub or the additional routing hub. The association may be determined based on factors such as proximity of the route's delivery addresses to each hub, current capacity at each hub, or specialized capabilities required for certain packets. In some aspects, the association of routes to hubs is dynamically adjusted based on real-time conditions such as traffic or weather events. For example, routes may be associated with the hub that allows for the shortest overall travel time, considering both the distance to the first delivery point and the total route length. In another example, routes may be balanced between hubs to ensure even distribution of workload and prevent bottlenecks at any single location.

In some implementations, the generation of the plurality of routes of provisioning tasks includes associating each of the plurality of routes of provisioning tasks with the primary routing hub or the additional routing hub. The route generation process can incorporate hub association as an integral part of route creation, rather than performing association as a separate step after routes are generated. For example, a route planning algorithm can determine, during route creation, whether a particular route should originate from the primary routing hub or the additional routing hub based on proximity to delivery addresses, traffic patterns, or delivery time windows. In some implementations, the route generation process can evaluate multiple potential hub assignments for each route and select the optimal assignment that minimizes total delivery time or distance. In an example, when generating a route for deliveries in a suburban area located between two routing hubs, the system can calculate the total route efficiency with each potential hub assignment and automatically associate the route with the hub that provides better overall performance metrics. The combined generation and association process can reduce computational overhead by eliminating the need for a separate post-processing step to assign routes to hubs after route generation is complete.

A route cluster engine can generate clusters of routes associated with different routing hubs based on various factors such as geographic proximity, delivery density, and hub capacity. In some implementations, the route cluster engine can analyze the generated routes and group them into distinct clusters, each associated with a specific routing hub. For example, as illustrated in FIG. 4, the first set of routes 415 forms a cluster associated with the primary hub 410, while the second set of routes 425 forms a separate cluster associated with the additional hub 420. The clustering process can consider factors such as the distance between delivery points, the overall route efficiency, and the capacity constraints of each hub. In some implementations, the route cluster engine can dynamically adjust the clusters based on real-time conditions or changes in delivery patterns. For instance, as shown in FIG. 6, the second set of routes 615 and the third set of routes 625 may be clustered around the first hub 510 and the second hub 620, respectively, based on their geographic distribution and the relative locations of the hubs. Similarly, FIG. 7 demonstrates how the fourth set of routes 725 and the fifth set of routes 735 can be clustered around the second hub 620 and the third hub 730, respectively, to optimize delivery efficiency across a larger geographic area. The route clustering approach can help balance workload among multiple hubs, reduce overall travel distances, and improve delivery times by assigning routes to the most appropriate hub based on various operational factors.

At operation 960, the plurality of packets is routed to the primary routing hub or the additional routing hub for retrieval by provisioning agents (e.g., delivery drivers). The routing of packets may involve physical transportation of items as well as updating digital tracking systems to reflect the movement of packets through the network. In some implementations, the routing process includes sorting packets at their origin points to streamline handling at the hubs. For example, packets may be loaded onto trucks or conveyor systems that correspond to their assigned hub, reducing the need for additional sorting upon arrival. In another example, provisioning agents may be notified of incoming packet volumes and types, allowing them to prepare appropriate resources for efficient retrieval and subsequent delivery.

The routing hubs can include sorting systems for organizing packages into routes of provisioning tasks. In some implementations, the sorting systems can comprise conveyor belts, automated scanners, and robotic arms that process incoming packages. For example, as packages arrive at a routing hub, automated scanners can read barcodes or RFID tags on the packages to identify their destination addresses and associated route information. Based on this data, the packages can be automatically sorted into bins or onto secondary conveyors corresponding to specific routes. In some implementations, the sorting process can dynamically adjust based on real-time route updates or changes in package volume. For instance, if a particular route becomes overloaded, the sorting system can redistribute packages to alternative routes to balance workload. The sorting systems can also prioritize packages based on delivery time requirements, placing time-sensitive items into expedited processing lanes. In some cases, the routing hubs can employ machine learning algorithms to optimize the sorting process, learning from historical data to predict and preemptively address potential bottlenecks or inefficiencies in the sorting workflow.

Provisioning agents, such as delivery drivers, can retrieve packets corresponding to their assigned routes from the designated routing hubs where the packets are stored. In some implementations, the routing system can generate pickup instructions for each provisioning agent, specifying the hub location, time window for pickup, and details of the assigned route. For example, a delivery driver may receive a notification on a mobile device indicating that packets for their route are ready for pickup at a specific hub between 6:00 AM and 7:00 AM. Upon arrival at the hub, the provisioning agent can present identification or scan a unique QR code to gain access to the designated pickup area. In some cases, the hub may utilize automated storage and retrieval systems, where packets for each route are pre-sorted and stored in specific lockers or zones. For instance, a driver may be directed to a particular bay or shelf where all packets for their route are consolidated, streamlining the pickup process. In other implementations, hub personnel or robotic systems may assemble the packets for each route on demand when the provisioning agent arrives. The system can also provide the provisioning agent with a digital manifest of the packets to be picked up, allowing for real-time verification and inventory management during the pickup process. In some aspects, the pickup process may include a brief quality check or final sorting step, where the provisioning agent confirms that all packets match the assigned route and are in proper condition for delivery.

In an example, a logistics company operates a package delivery service in a metropolitan area. The company obtains packet data for 10,000 packages scheduled for delivery the following day. The packet data includes delivery addresses, package dimensions, weight, and delivery time windows for each package.

The company identifies the location of its primary routing hub, a large warehouse facility situated near the city center. This primary hub serves as the main distribution point for the majority of deliveries in the urban core.

Based on the packet data and the location of the primary routing hub, the company determines the need for an additional routing hub to serve the rapidly growing suburban areas to the north. The company selects a location for this additional hub by analyzing the distribution of delivery addresses in the packet data, considering factors such as population density, road network accessibility, and proximity to major highways.

The company generates a plurality of routes for provisioning tasks using a sophisticated routing algorithm. The algorithm takes into account the packet data, including delivery addresses and time windows, as well as historical traffic patterns and real-time road conditions. The routing algorithm creates 200 distinct delivery routes, each optimized for efficiency and designed to meet the specified delivery time windows.

In the route generation process, the algorithm associates each of the 200 routes with either the primary routing hub or the additional routing hub. Routes primarily serving the city center and southern suburbs are associated with the primary hub, while routes covering the northern suburban areas are linked to the additional hub. For example, a route with 50 delivery stops in the downtown area is associated with the primary hub, whereas a route with 40 stops in a northern residential district is assigned to the additional hub.

The company then routes the 10,000 packages to either the primary routing hub or the additional routing hub based on their assigned delivery routes. Packages destined for addresses in the city center and southern suburbs are transported to the primary hub during the night. Simultaneously, packages for northern suburban deliveries are moved to the additional hub.

At each hub, an automated sorting system organizes the packages into their respective delivery routes. The sorting system at the primary hub processes 6,000 packages, while the additional hub handles 4,000 packages. Conveyor belts transport the packages past barcode scanners that read the destination information and route assignments. Robotic arms then sort the packages into designated bins corresponding to each delivery route.

Delivery drivers arrive at their assigned hubs early in the morning. A driver assigned to a route in the northern suburbs receives a notification on their mobile device at 5:30 AM, instructing them to pick up their packages at the additional hub between 6:15 AM and 6:45 AM. Upon arrival, the driver scans a unique QR code at the hub entrance, granting them access to the loading area.

The driver is directed to a specific loading bay where their route's packages are consolidated. The driver verifies the packages against a digital manifest provided on their mobile device, confirming that all 40 packages for their route are present and in good condition. After loading the packages into their delivery vehicle, the driver begins their route at 7:00 AM, following the optimized delivery sequence generated by the routing algorithm.

Throughout the day, the routing system monitors the progress of all 200 delivery routes. Real-time GPS data from the delivery vehicles is used to update estimated delivery times and detect any potential delays. In one instance, when a traffic accident causes significant delays on a major highway, the system dynamically adjusts the routes of five affected drivers, rerouting them to alternative roads to minimize delivery disruptions.

By the end of the day, the company successfully delivers 9,950 of the 10,000 packages, with the remaining 50 packages rescheduled due to various factors such as recipient unavailability or address issues. The implementation of the additional routing hub results in a 15% reduction in average stem time for drivers and a 10% increase in the number of packages delivered per hour compared to the previous single-hub system.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method, comprising:
obtaining packet data including provisioning targets for a plurality of packets;
identifying a location of a primary routing hub for routing the plurality of packets;
determining a location for an additional routing hub based on the packet data and the location of the primary routing hub;
generating, based on the packet data, a plurality of routes of provisioning tasks;
associating each of the plurality of routes of provisioning tasks with the primary routing hub or the additional routing hub; and
routing the plurality of packets to the primary routing hub or the additional routing hub for retrieval by provisioning agents.

2. The method of claim 1, wherein the plurality of routes of provisioning tasks are generated based on the packet data and the locations of the primary routing hub and the additional routing hub.

3. The method of claim 1, wherein generating the plurality of routes of provisioning tasks includes associating each of the plurality of routes of provisioning tasks with the primary hub or the additional routing hub.

4. The method of claim 1, wherein the packet data comprises predicted packet data, the method further comprising executing a packet forecast machine-learning model using as input historical packet data to generate the predicted packet data.

5. The method of claim 1, further comprising determining execution data based on the provisioning targets for the plurality of packets and path data, wherein the execution data comprises at least one of execution distance and execution time.

6. The method of claim 5, wherein the plurality of routes of provisioning tasks are generated based on the packet data and the execution data.

7. The method of claim 1, wherein determining the location for the additional routing hub comprises selecting the location from a set of predetermined candidate locations.

8. The method of claim 1, further comprising determining a location for a second additional routing hub.

9. The method of claim 1, further comprising receiving user input indicating a target number of routing hubs.

10. The method of claim 1, further comprising determining a number of routing hubs based on a cost of additional routing hubs and execution data comprising at least one of execution distance and execution time.

11. A non-transitory, computer-readable medium including instructions which, when executed by one or more processors cause the one or more processors to:
obtain packet data including provisioning targets for a plurality of packets;
identify a location of a primary routing hub for routing the plurality of packets;
determine a location for an additional routing hub based on the packet data and the location of the primary routing hub;
generate, based on the packet data, a plurality of routes of provisioning tasks;
associate each of the plurality of routes of provisioning tasks with the primary routing hub or the additional routing hub; and
route the plurality of packets to the primary routing hub or the additional routing hub for retrieval by provisioning agents.

12. The non-transitory, computer-readable medium of claim 11, wherein the instructions cause the one or more processors to generate the plurality of routes of provisioning tasks based on the packet data and the locations of the primary routing hub and the additional routing hub.

13. The non-transitory, computer-readable medium of claim 11, wherein the instructions cause the one or more processors to associate each of the plurality of routes of provisioning tasks with the primary hub or the additional routing hub during generation of the plurality of routes of provisioning tasks.

14. The non-transitory, computer-readable medium of claim 11, wherein the packet data comprises predicted packet data, and wherein the instructions cause the one or more processors to execute a packet forecast machine-learning model using as input historical packet data to generate the predicted packet data.

15. The non-transitory, computer-readable medium of claim 11, wherein the instructions cause the one or more processors to determine execution data based on the provisioning targets for the plurality of packets and path data, wherein the execution data comprises at least one of execution distance and execution time.

16. The non-transitory, computer-readable medium of claim 15, wherein the instructions cause the one or more processors to generate the plurality of routes of provisioning tasks based on the packet data and the execution data.

17. The non-transitory, computer-readable medium of claim 11, wherein the instructions cause the one or more processors to determine the location for the additional routing hub by selecting the location from a set of predetermined candidate locations.

18. The non-transitory, computer-readable medium of claim 11, wherein the instructions cause the one or more processors to determine a location for a second additional routing hub.

19. The non-transitory, computer-readable medium of claim 11, wherein the instructions cause the one or more processors to receive user input indicating a target number of routing hubs.

20. The non-transitory, computer-readable medium of claim 11, wherein the instructions cause the one or more processors to determine a number of routing hubs based on a cost of additional routing hubs and execution data comprising at least one of execution distance and execution time.
